(19) United States
(12) Patent Application Publication
(10) Pub. No.: US 2012/0143478 A1
(43) Pub. Date: Jun. 7, 2012

(54) FUEL INJECTION CONTROL METHOD FOR GDI ENGINE

(75) Inventor: Wanho Kim, Seoul (KR)

(73) Assignee: Hyundai Motor Company, Seoul (KR)

(21) Appl. No.: 13/227,126

(22) Filed: Sep. 7, 2011

(30) Foreign Application Priority Data
Dec. 1, 2010 (KR) 10-2010-0121516

(51) Int. Cl. F02D 41/30

(52) U.S. Cl. 701/104; 701/105

(57) ABSTRACT

It is possible to ensure good starting performance and operability of an engine, reduce starting time with improved combustion stability, and improve noise vibration harshness (NVH), regardless of whether the engine is started at low temperature even if a high-pressure fuel pump in a gasoline direct injection (GDI) engine breaks, without using an additional dedicated device.

### CROSS-REFERENCE TO RELATED APPLICATIONS

The present application claims priority to Korean Patent Application Number 10-2010-0121516 filed Dec. 1, 2010, the entire contents of which application is incorporated herein for all purposes by this reference.

### BACKGROUND OF INVENTION

1. Field of Invention

The present invention relates to a fuel injection control method of a GDI engine, and more particularly, to a technology of injecting fuel, with good start performance and operability of an engine even if a high-pressure fuel pump fails.

2. Description of Related Art

Gasoline direct injection (GDI) engines are gasoline engines that directly inject fuel into a combustion chamber, in which fuel supplied from a low-pressure fuel pump in a fuel tank is increased in pressure by a high-pressure fuel pump and then supplied to an injector, in order for the fuel to be directly injected in to the combustion chamber.

The fuel injection method of the GDI engine is basically divided into two injection methods, compression injection and intake injection, and division injection combining them is also used.

The compressing injection is generally used to start the engine and reduces the amount of fuel for starting the engine by injecting the fuel in the compression stroke such that the gas mixture is dense around the ignition plug.

The intake injection is used for common injection, reduces the intake temperature by injecting the fuel in the intake stroke, and is advantageous in making uniform gas mixture by preparing the compression injection, using intake flow.

In the related art, when fuel injection under high pressure is impossible in a combustion chamber due to a breakdown of a high-pressure fuel pump in the GDI engine, fuel is supplied to the injector under lower temperature than a normal state, such that the intake injection control is performed, instead of the compression injection control, even in starting the engine.

In this case, a larger amount of fuel is required for starting the engine, as compared with the compression injection control, such that fuel is additionally further injected, in addition to the basic amount of fuel for starting the engine in order to start the engine.

Further, common normal control is performed, similar to when the high-pressure pump has been in the normal state, after the engine is started.

However, there is a problem in that when the high-pressure fuel pump breaks and the engine is started at low temperature, for example, 20 degrees below zero, it is impossible to start the engine only by further injecting the fuel other than the basic amount of fuel for starting the engine, and even if the engine is started, combustion stability in the worm-up section of the engine is deteriorated.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a fuel injection control method for a GDI engine that can ensure good starting performance and operability of an engine, regardless of whether the engine is started at low temperature, when a high-pressure fuel pump in the GDI engine breaks, and can improve NVH performance and reduce starting time, with improved combustion stability.

Various aspects of the present invention provide for a fuel injection control method for a GDI engine, which comprises determining whether fuel pressure is at a low level where normal fuel pressure is difficult to be made by a high-pressure fuel pump, setting a fuel injection end time that restricts the fuel injection end time within a range where the fuel pressure is larger than combustion chamber pressure, when the fuel pressure is at a low level, calculating the amount of fuel right after starting engine that determines the fuel injection amount in a function of engine cooling water temperature and fuel pressure, independently from the normal fuel pressure right after the engine is started, when the fuel pressure is at a low level, and calculating an advance amount of a fuel injection starting time that determines the advance amount of a fuel injection starting time in consideration of fuel injection time at low pressure taken to inject all the required fuel, when the fuel pressure is at a low level.

According to various aspects of the present invention, it is possible to ensure good starting performance and operability of an engine, reduced starting time with improved combustion stability, and improve noise vibration harshness (NVH), regardless of whether the engine is started at low temperature even if a high-pressure fuel pump in a GDI engine breaks, without using an additional device.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a flowchart illustrating an exemplary fuel injection control method for a GDI engine according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

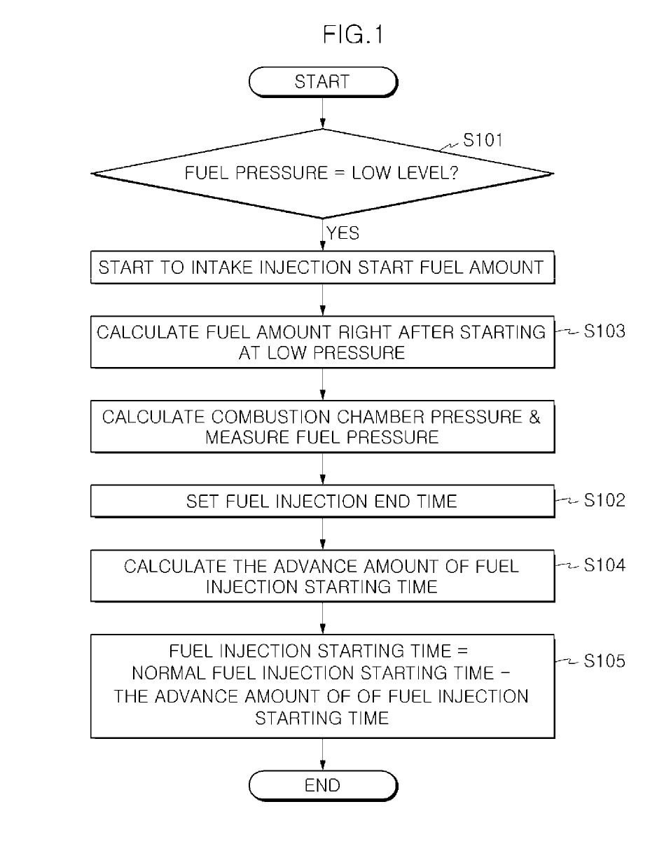

Referring to FIG. 1, various embodiments of the present invention includes determining whether fuel pressure is at a low level where normal fuel pressure is difficult to be made by a high-pressure fuel pump (S101), setting a fuel injection end time that restricts the fuel injection end time within a range where the fuel pressure is larger than combustion chamber pressure, when the fuel pressure is at a low level (S102), calculating the amount of fuel right after starting that determines the fuel injection amount in a function of engine cooling water temperature and fuel pressure, independently from the normal fuel pressure right after the engine is started, when the fuel pressure is at a low level (S103), and calculating an advance amount of a fuel injection starting time that determines the advance amount of the fuel injection starting time in consideration of fuel injection time at low pressure taken to inject all the required fuel, when the fuel pressure is at a low level (S104).

After it is determined whether the fuel pressure is at a low level, all of the setting a fuel injection end time (S102), the calculating the amount of fuel right after starting (S103), and the calculating the advance amount of the fuel injection starting time (S104) is not performed together, and each or combination of them may be selectively controlled, if necessary.

Since it is difficult to make the normal fuel pressure due to breakdown of the high-pressure fuel pump, when the fuel pressure is at a low level, the compression pressure of the combustion chamber may become larger than the fuel injection pressure of the injector when the fuel is injected, in which the gas mixture in the combustion chamber may flow backward to the injector and the fuel rail and the fire may be extinguished and the engine may not be started until this phenomenon is removed.

Therefore, the setting a fuel injection end time (S102) is performed to prevent the state described above in this embodiment.

The setting a fuel injection end time (S102) sets the fuel injection end time before a time where a difference between the fuel pressure measured by a fuel pressure sensor and the combustion pressure calculated by modeling is 0 or more such that fuel is injected only to the time where the fuel injection pressure is larger than the pressure of the combustion chamber when the fuel is injected from the injector, thereby preventing the gas mixture from flowing backward to the injector, as described above.

In this configuration, the combustion chamber pressure is acquired by multiplying all of the intake manifold pressure, the cylinder volume efficiency, a compression ratio according to a crank angle measured by a test, and a compensation value according to a change in phase angle of an intake cam which is set by a test.

That is, it is calculated by the following formula.

Combustion chamber pressure=(intake manifold pressure×cylinder volume efficiency)×compression ratio according to crank angle (set by a test)×compensation value according to a change in phase angle of intake cam (set by a test).

Meanwhile, the calculating the amount of fuel right after starting (S103) determines the amount of fuel injection from a map that is a function of engine cooling water temperature and fuel pressure, independent from the normal fuel pressure, right after the engine is started when the fuel pressure is at a low level.

That is, since fuel is injected under fuel pressure very smaller than the fuel pressure of the normal intake injection when the fuel pressure is at a low level, when normal control of fuel amount is performed right after the engine is started, the fuel substantially injected into the combustion chamber is insufficient and unstable combustion occurs, such that the engine may stop. Therefore, the amount of fuel injection is made denser than the normal control of the amount of fuel.

Therefore, when amount of fuel is controlled right after the engine is started at the amount of fuel injection determined denser than the normal state, combustion stability of the engine is improved and the engine can be prevented from stopping.

Meanwhile, the end time of fuel injection is later than the normal state even if the same amount of fuel is injected when the fuel pressure is at a low level, such that the fuel injection is started at the same time as the normal state, the time taken to make a gas mixture after fuel injection becomes short, and accordingly, the combustion stability of the engine is deteriorated, and particularly, this phenomenon becomes worse in worming-up of the engine.

Therefore, the fuel injection time is advanced more than the normal state in accordance with the advance amount of the fuel injection starting time which is calculated by the calculating the advance amount of the fuel injection starting time (S104), thereby improving combustion stability.

The calculating the advance amount of the fuel injection starting time (S104) calculates a required advance time of the fuel injection starting time, by subtracting the normal fuel injection time, which is determined as a function of desired pressure and the required amount of fuel from the fuel injection time at low pressure which is determined as a function of the current fuel pressure and required amount of fuel, and changes the required advance time of the fuel injection starting time into the advance amount of the fuel injection starting time, in the crank angle unit.

That is, the required advance time of the fuel injection starting time (ms)=fuel injection time at low pressure−normal fuel injection time.

The required advance time of the fuel injection starting time (ms) is changed into the advance amount of the fuel injection starting time, by the following formula.

Advance amount of a fuel injection starting time (crank angle)=required advance time of fuel injection starting time (ms)/time for one rotation (ms)×360(crank angle)=required advance time of fuel injection starting time (ms)/(1/[revolution number of engine (rpm)/60]×1000)×360(crank angle)=required advance time of fuel injection starting time (ms)×revolution number of engine (rpm)×0.006.

Further, the exemplary embodiment further includes acquiring fuel injection starting time at low pressure in the crank angle unit, by subtracting the advance amount of fuel injection starting time from the normal fuel injection starting time (S105).

Therefore, an engine controller performs control such that fuel is directly injected at the fuel injection starting time at low pressure acquired in the crank angle unit, such that the actual fuel injection starting time is advanced and a sufficient gas mixture is generated after the fuel is injected, thereby improving combustion stability.

Obviously, the fuel injection starting time at low pressure should be limited in a range after the intake top dead center (TDC) where the intake process starts.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A fuel injection control method for a gasoline direct injection (GDI) engine, the method comprising:
determining whether fuel pressure is at a low level where a normal fuel pressure is not properly supplied by a high-pressure fuel pump;
setting a fuel injection end time that restricts the fuel injection end time within a range where the fuel pressure is larger than combustion chamber pressure, when the fuel pressure is at a low level;
calculating the amount of fuel right after starting that determines the fuel injection amount in a function of engine cooling water temperature and fuel pressure, independently from the normal fuel pressure right after the engine is started, when the fuel pressure is at a low level; and
calculating an advance amount of a fuel injection starting time that determines the advance amount of a fuel injection starting time in consideration of fuel injection time at low pressure taken to inject all the required fuel, when the fuel pressure is at a low level.

2. The fuel injection control method for a GDI engine as defined in claim 1, wherein the setting a fuel injection end time sets the fuel injection end time before a time where a difference between the fuel pressure measured by a fuel pressure sensor and the combustion pressure calculated by modeling is 0 or more; and
the combustion chamber pressure is determined by multiplying all of the intake manifold pressure, the cylinder volume efficiency, a compression ratio according to a crank angle measured by a test, and a compensation value according to a change in phase angle of an intake cam which is set by a test.

3. The fuel injection control method for a GDI engine as defined in claim 1, wherein the calculating the advance amount of the fuel injection starting time calculates a required advance time of the fuel injection starting time, by subtracting the normal fuel injection time, which is determined as a function of desired pressure and the required amount of fuel from the fuel injection time at low pressure which is determined as a function of the current fuel pressure and required amount of fuel; and changes the required advance time of the fuel injection starting time into the amount of an advance angle of the fuel injection starting time, in the crank angle unit.

4. The fuel injection control method for a GDI engine as defined in claim 3, further comprising: acquiring fuel injection starting time at low pressure in the crank angle unit, by subtracting the advance amount of the fuel injection starting time from the normal fuel injection starting time.

5. The fuel injection control method for a GDI engine as defined in claim 4, wherein the fuel injection starting time at low pressure should be limited in a range after the intake top dead center (TDC) where the intake process starts.

6. A fuel injection control method for a gasoline direct injection (GDI) engine, the method comprising:
determining whether fuel pressure is at a low level where normal fuel pressure is difficult to be made by a high-pressure fuel pump; and
setting a fuel injection end time that restricts the fuel injection end time within a range where the fuel pressure is larger than combustion chamber pressure, when the fuel pressure is at a low level.

7. The fuel injection control method for a GDI engine as defined in claim 6, wherein the setting a fuel injection end time sets the fuel injection end time before a time where a difference between the fuel pressure measured by a fuel pressure sensor and the combustion pressure calculated by modeling is 0 or more; and
the combustion chamber pressure is determined by multiplying all of the intake manifold pressure, the cylinder volume efficiency, a compression ratio according to a crank angle measured by a test, and a compensation value according to a change in phase angle of an intake cam which is set by a test.

8. A fuel injection control method for a gasoline direct injection (GDI) engine, the method comprising:
determining whether fuel pressure is at a low level where normal fuel pressure is difficult to be made by a high-pressure fuel pump; and
calculating the amount of fuel right after starting that determines the fuel injection amount in a function of engine cooling water temperature and fuel pressure, independently from the normal fuel pressure right after the engine is started, when the fuel pressure is at a low level.

9. A fuel injection control method for a gasoline direct injection (GDI) engine, the method comprising:
determining whether fuel pressure is at a low level where normal fuel pressure is difficult to be made by a high-pressure fuel pump; and
calculating the advance amount of a fuel injection starting time that determines the advance amount of the fuel injection starting time in consideration of fuel injection time at low pressure taken to inject all the required fuel, when the fuel pressure is at a low level.

10. The fuel injection control method for a GDI engine as defined in claim 9, wherein the calculating the advance amount of the fuel injection starting time calculates a required advance time of a fuel injection starting time, by subtracting the normal fuel injection time which is determined as a function of desired pressure and the required amount of fuel from the fuel injection time at low pressure which is determined as a function of the current fuel pressure and required amount of fuel; and
changes the required advance time of the fuel injection starting time into the advance amount of the fuel injection starting time in the crank angle unit.

11. The fuel injection control method for a GDI engine as defined in claim 10, further comprising: acquiring fuel injection starting time at low pressure in the crank angle unit, by subtracting the advance amount of the fuel injection starting time from the normal fuel injection starting time.

12. The fuel injection control method for a GDI engine as defined in claim 11, wherein the fuel injection starting time at low pressure should be limited in a range after the intake top dead center (TDC) where the intake process starts.
